(19) United States
(12) Patent Application Publication
(10) Pub. No.: US 2024/0404759 A1
(43) Pub. Date: Dec. 5, 2024

(54) MULTILAYER CERAMIC CAPACITOR

(71) Applicant: Murata Manufacturing Co., Ltd., Nagaokakyo-shi (JP)

(72) Inventors: Takeshi SUGATA, Nagaokakyo-shi (JP); Shougo KANETA, Nagaokakyo-shi (JP)

(21) Appl. No.: 18/802,017

(22) Filed: Aug. 13, 2024

Related U.S. Application Data
(63) Continuation of application No. PCT/JP2023/015321, filed on Apr. 17, 2023.

(30) Foreign Application Priority Data
Jun. 8, 2022 (JP) 2022-092697

(51) Int. Cl. H01G 4/30; H01G 4/008; H01G 4/012; H01G 4/12; H01G 4/232

(52) U.S. Cl. CPC H01G 4/30; H01G 4/008; H01G 4/012; H01G 4/1227; H01G 4/232

(57) ABSTRACT

A multilayer ceramic capacitor includes a multilayer body including dielectric layers and internal electrode layers, first and second main surfaces opposed to each other in a lamination direction, first and second lateral surfaces opposed to each other in a width direction, and first and second end surfaces opposed to each other in a length direction, and first and second external electrodes respectively on the first and second end surfaces. Each of the first and second external electrodes includes a base electrode layer, a lower plated layer on the base electrode layer, and an upper plated layer on the lower plated layer. Each of the lower plated layers has an average thickness of about 2.0 μm or more and about 5.0 μm or less, and includes thin layer regions with a thickness smaller than the average thickness of the lower plated layer.

### CROSS REFERENCE TO RELATED APPLICATIONS

This application claims the benefit of priority to Japanese Patent Application No. 2022-092697 filed on Jun. 8, 2022 and is a Continuation Application of PCT Application No. PCT/JP2023/015321 filed on Apr. 17, 2023. The entire contents of each application are hereby incorporated herein by reference.

### BACKGROUND OF THE INVENTION

### 1. Field of the Invention

The present invention relates to multilayer ceramic capacitors.

### 2. Description of the Related Art

In general, a multilayer ceramic capacitor includes a sintered ceramic body made of a dielectric ceramic such as barium titanate and having a rectangular parallelepiped outer shape. Inside the sintered ceramic body, a plurality of internal electrodes each corresponding to a positive electrode or a negative electrode are stacked on top of another with ceramic layers therebetween. External electrodes are formed on one end surface and an opposite end surface in the longitudinal direction of the sintered ceramic body. The external electrodes are selectively connected to the plurality of internal electrodes and used to mount the multilayer ceramic capacitor on an external mounting substrate.

The external electrodes each have a configuration including a laminate of a baked electrode layer that is directly electrically connected to the internal electrodes and a plated layer that are used to mount the multilayer ceramic capacitor on a mounting substrate by soldering (see, for example, Japanese Unexamined Patent Application, Publication No. H08-306580).

The foregoing conventional technology has disadvantages described below. A multilayer ceramic capacitor can be mounted on a mounting substrate. In such a mounted structure, in particular, the multilayer ceramic capacitor is required to have resistance to damage resulting from bending of the mounting substrate. In order to increase the resistance, it is considered effective to reduce the mechanical strength of the external electrodes less to enhance the ability of the multilayer ceramic capacitor to follow deformation of the mounting substrate.

To this end, preferably, the mechanical strength can be controlled by reducing the thickness of the plated layers in the external electrodes. However, reducing the thickness of the plated layers increases the likelihood of defective soldering, which creates a trade-off relationship. The plated layers are therefore formed under limited processing conditions.

### SUMMARY OF THE INVENTION

Example embodiments of the present invention provide multilayer ceramic capacitors that each, when mounted on a mounting substrate, enable satisfactory soldering while also achieving increased resistance to damage resulting from bending of the mounting substrate.

A multilayer ceramic capacitor according to an example embodiment of the present invention includes a multilayer body including a plurality of dielectric layers and a plurality of internal electrode layers laminated in a lamination direction, a first main surface and a second main surface opposed to each other in the lamination direction, a first lateral surface and a second lateral surface opposed to each other in a width direction orthogonal or substantially orthogonal to the lamination direction, and a first end surface and a second end surface opposed to each other in a length direction orthogonal or substantially orthogonal to the lamination direction and the width direction, a first external electrode on the first end surface, and a second external electrode on the second end surface. The first external electrode and the second external electrode each include a base electrode layer, a lower plated layer on a surface of the base electrode layer, and an upper plated layer on a surface of the lower plated layer. The lower plated layer has an average thickness of about 2.0 μm or more and about 5.0 μm or less. The lower plated layers includes thin layer regions with a thickness smaller than the average thickness of the lower plated layer.

Multilayer ceramic capacitors according to example embodiments of the present invention enable satisfactory soldering while also ensuring resistance to damage resulting from bending of a substrate, because defective soldering is prevented even when the thickness of the lower plated layers is partially reduced and the mechanical strength of the external electrodes is reduced, due to the configuration in which each of the lower plated layers has an average thickness of about 2.0 μm or more and about 5.0 μm or less, and each of the lower plated layers includes thin layer regions having a thickness smaller than the average thickness of the lower plated layer.

According to example embodiments of the present invention, it is possible to provide multilayer ceramic capacitors that each, when mounted on a mounting substrate, enable satisfactory soldering while also achieving increased resistance to damage resulting from bending of the mounting substrate.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is an external perspective view of an example of a multilayer ceramic capacitor according to an example embodiment of the present invention.

FIG. 2 is a cross-sectional view taken along line II-II in FIG. 1.

FIG. 3 is a cross-sectional view taken along line III-III in FIG. 1.

FIG. 4 is a plan view corresponding to a cross-section taken along line IV-IV in FIG. 2 and shows a configuration of internal electrode layers of a multilayer ceramic capacitor according to an example embodiment of the present invention.

FIG. 5A is a schematic diagram corresponding to the cross-sectional view taken along line II-II in FIG. 1 and schematically shows a structure in which a counter electrode portion of each internal electrode layer of a multilayer ceramic capacitor according to an example embodiment of the present invention is divided into two portions.

FIG. 5B is a schematic diagram corresponding to the cross-sectional view taken along line II-II in FIG. 1 and schematically shows a structure in which a counter electrode portion of each internal electrode layer of a multilayer ceramic capacitor according to an example embodiment of the present invention is divided into three portions.

FIG. 5C is a schematic diagram corresponding to the cross-sectional view taken along line II-II in FIG. 1 and schematically shows a structure in which a counter electrode portion of each internal electrode layer of a multilayer ceramic capacitor according to an example embodiment of the present invention is divided into four portions.

FIG. 6 is a cross-sectional view of a relevant portion of a first external electrode of a multilayer ceramic capacitor according to an example embodiment of the present invention.

### DETAILED DESCRIPTION OF THE EXAMPLE EMBODIMENTS

Example embodiments of the present invention will be described in detail below with reference to the drawings.

### 1. Multilayer Ceramic Capacitor

The following describes a multilayer ceramic capacitor 10 according to an example embodiment of the present invention.

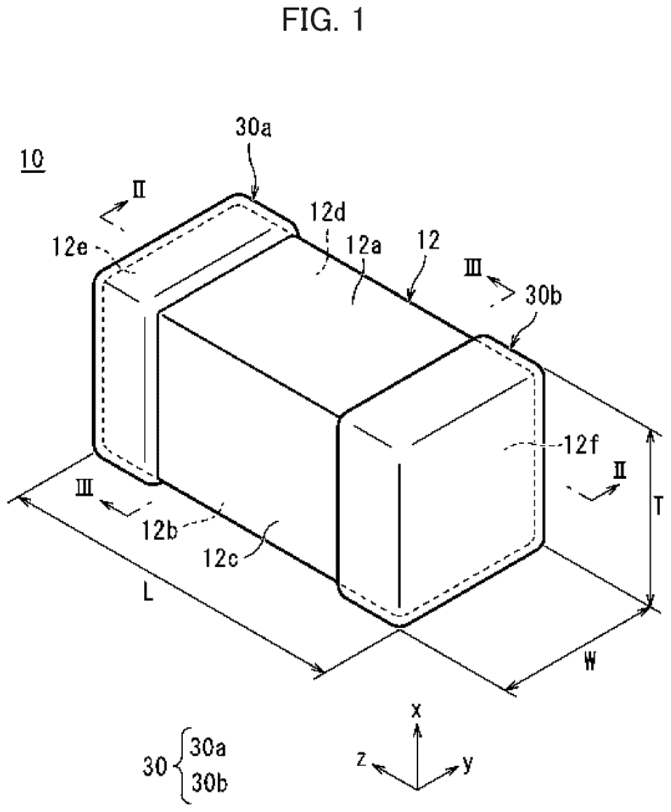

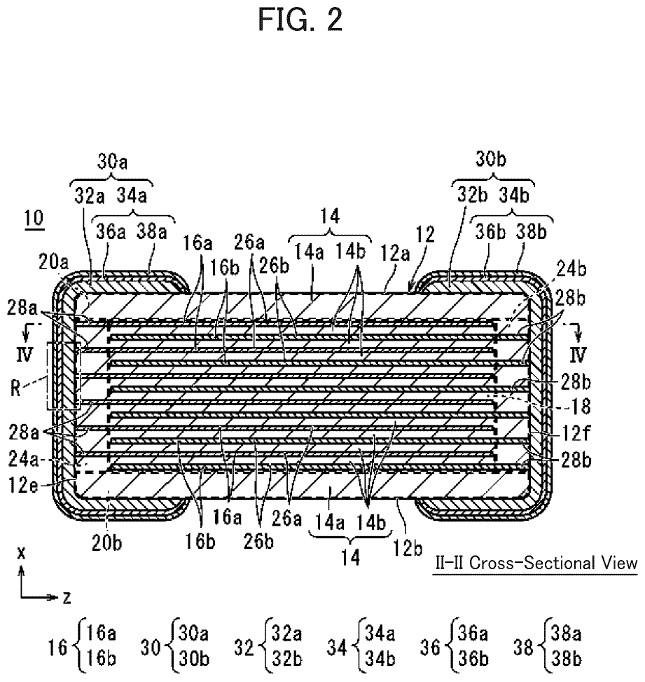

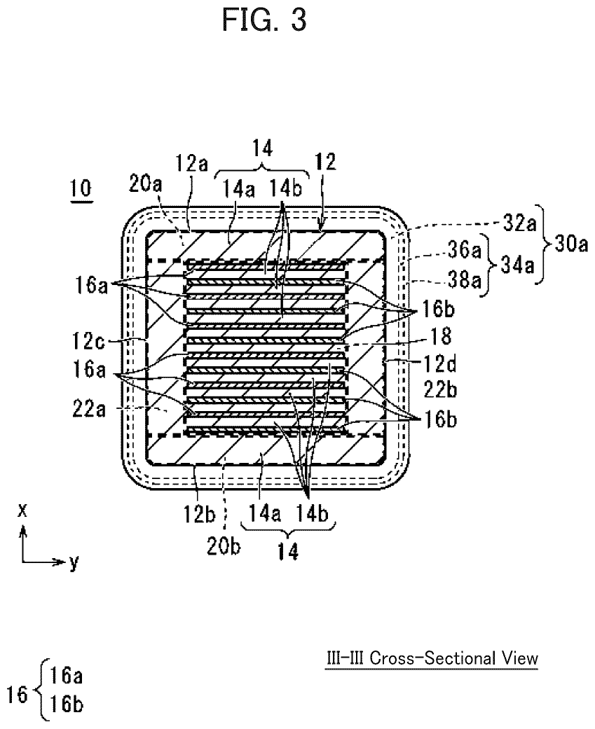

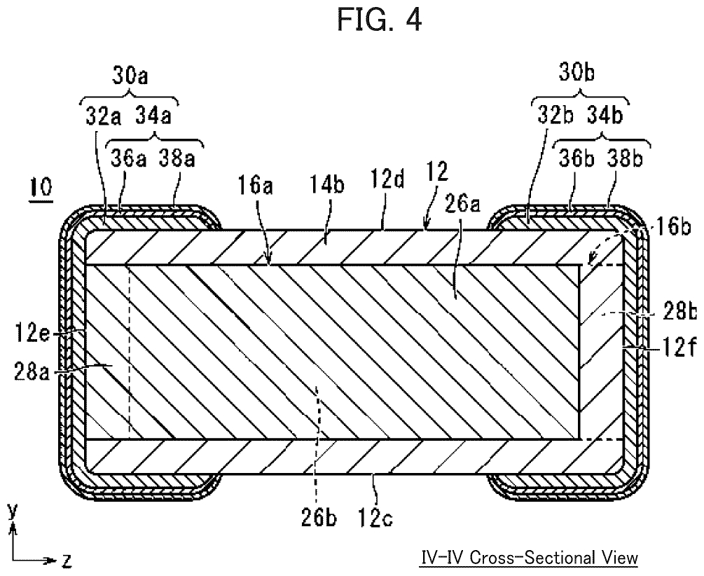

FIG. 1 is an external perspective view of a configuration of a multilayer ceramic capacitor according to an example embodiment of the present invention. FIG. 2 is a cross-sectional view taken along line II-II in FIG. 1. FIG. 3 is a cross-sectional view taken along line III-III in FIG. 1. FIG. 4 is a plan view corresponding to a cross-section taken along line IV-IV in FIG. 2 and shows a configuration of internal electrode layers of the multilayer ceramic capacitor according to the present example embodiment of the present invention.

As shown in FIGS. 1 to 4, the multilayer ceramic capacitor 10 includes a multilayer body 12 and external electrodes 30 disposed on surfaces of the multilayer body 12.

As shown in FIG. 1, the multilayer body 12 included in the multilayer ceramic capacitor 10 has a rectangular or substantially rectangular parallelepiped shape. The “rectangular parallelepiped shape” encompasses a rectangular parallelepiped shape having rounded corner portions and ridge portions. That is, a member having a “rectangular parallelepiped shape” means a member in general having first and second main surfaces 12a and 12b, first and second lateral surfaces 12c and 12d, and first and second end surfaces 12e and 12f.

More specifically, the multilayer body 12 includes the first main surface 12a and the second main surface 12b opposed to each other, the first lateral surface 12c and the second lateral surface 12d opposed to each other while connecting the first main surface 12a and the second main surface 12b, and the first end surface 12e and the second end surface 12f extending in a direction orthogonal or substantially orthogonal to the first lateral surface 12c and the second lateral surface 12d, and opposed to each other while connecting the first main surface 12a and the second main surface 12b.

Corner portions and ridge portions of the multilayer body 12 may be angular or rounded. The corner portions each refer to a portion where three adjacent surfaces of the multilayer body 12 intersect, and the ridge portions each refer to a portion where two adjacent surfaces of the multilayer body 12 intersect.

Some or all of the first and second main surfaces 12a and 12b, the first and second lateral surfaces 12c and 12d, and the first and second end surfaces 12e and 12f may include irregularities such as projections and recesses, for example.

A direction that connects the first main surface 12a and the second main surface 12b of the multilayer body 12 is defined as a height direction x. A direction that is orthogonal or substantially orthogonal to the height direction x, and connects the first lateral surface 12c and the second lateral surface 12d is defined as a width direction y. A direction that is orthogonal or substantially orthogonal to the height direction x and the width direction y, and connects the first end surface 12e and the second end surface 12f is defined as a length direction z. In the following description, a dimension in the length direction z, a dimension in the height direction x, and a dimension in the width direction y with respect to the multilayer ceramic capacitor 10 including the multilayer body 12 and the external electrodes 30 described below are referred to as an L dimension, a T dimension, and a W dimension, respectively. These terms are used in the following description.

In the multilayer body 12, a plurality of dielectric layers 14 and a plurality of internal electrode layers 16 are laminated in the height direction x.

The multilayer body 12 includes an inner layer portion 18 including one or a plurality of dielectric layers 14b and a plurality of internal electrode layers 16 disposed on the dielectric layers 14b. In the inner layer portion 18, the plurality of internal electrode layers 16 are opposed to each other with the dielectric layers 14b therebetween.

The multilayer body 12 includes a first main surface-side outer layer portion 20a that is located on a first main surface 12a side, and that includes a plurality of dielectric layers 14a located between the first main surface 12a, an outermost surface of the inner layer portion 18 on the first main surface 12a side, and a straight line along this outermost surface. The multilayer body 12 also includes a second main surface-side outer layer portion 20b that is located on a second main surface 12b side, and that includes a plurality of dielectric layers 14a located between the second main surface 12b, an outermost surface of the inner layer portion 18 on the second main surface 12b side, and a straight line along this outermost surface.

The multilayer body 12 includes a first lateral surface-side outer layer portion 22a that is located on a first lateral surface 12c side, and that includes a plurality of dielectric layers 14b located between the first lateral surface 12c and an outermost surface of the inner layer portion 18 on the first lateral surface 12c side. The multilayer body 12 also includes a second lateral surface-side outer layer portion 22b that is located on a second lateral surface 12d side, and that includes a plurality of dielectric layers 14b located between the second lateral surface 12d and an outermost surface of the inner layer portion 18 on the second lateral surface 12d side.

The multilayer body 12 includes a first end surface-side outer layer portion 24a that is located on a first end surface 12e side, and that includes a plurality of dielectric layers 14b located between the first end surface 12e and an outermost surface of the inner layer portion 18 on the first end surface 12e side. The multilayer body 12 also includes a second end surface-side outer layer portion 24b that is located on a second end surface 12f side, and that includes a plurality of dielectric layers 14b located between the second end surface 12f and an outermost surface of the inner layer portion 18 on the second end surface 12f side.

No particular limitations are provided for the dimensions of the multilayer body 12.

Examples of materials for forming the dielectric layers 14 include a ceramic material as a dielectric material. Examples of usable dielectric materials include a dielectric ceramic containing BaTiO₃, CaTiO₃, SrTiO₃, or CaZrO₃ as a main component.

In addition to the main component, the material for forming the dielectric layers 14 may include a subcomponent in a smaller amount than the main component depending on desired properties of the multilayer body 12. Examples of subcomponents include a Mn compound, an Fe compound, a Cr compound, a Co compound, or a Ni compound.

Any number of dielectric layers 14 may be laminated. The number of dielectric layers 14 herein means the total number of dielectric layers 14 including the number of dielectric layers 14 of the inner layer portion 18, and the number of dielectric layers of the first main surface-side outer layer portion 20a and the second main surface-side outer layer portion 20b.

Preferably, the dielectric layers 14 have, for example, a thickness of about 0.5 μm or more and about 10 μm or less.

The multilayer body 12 includes, for example, a plurality of first internal electrode layers 16a and a plurality of second internal electrode layers 16b that have a rectangular or substantially rectangular shape as the plurality of internal electrode layers 16. The first internal electrode layers 16a and the second internal electrode layers 16b are embedded and alternately arranged at equal or substantially equal intervals in the height direction x of the multilayer body 12 with the dielectric layers 14 therebetween. Each of the first internal electrode layers 16a and the second internal electrode layers 16b is parallel or substantially parallel to the first main surface 12a and the second main surface 12b. The first internal electrode layers 16a and the second internal electrode layers 16b are opposed to each other in the height direction x with the dielectric layers 14 therebetween.

For ease of explanation, for example, the drawings each show a multilayer body including six first internal electrode layers 16a arranged from top to bottom in the height direction x as the plurality of first internal electrode layers 16a and six second internal electrode layers 16b arranged from top to bottom in the height direction x as the plurality of second internal electrode layers 16b. However, this configuration is merely an example, and the multilayer body 12 may include any suitable number of first and second internal electrode layers 16a and 16b.

The first internal electrode layers 16a and the second internal electrode layers 16b are respectively disposed on the dielectric layers 14 and located inside the multilayer body 12.

The first internal electrode layers 16a are disposed on the plurality of dielectric layers 14 and located inside the multilayer body 12. Each of the first internal electrode layers 16a includes a first counter electrode portion 26a opposed to adjacent second internal electrode layers 16b, and a first extension electrode portion 28a that is located at one end of the first internal electrode layer 16a and extends from the first counter electrode portion 26a to the first end surface 12e of the multilayer body 12. An end of the first extension electrode portion 28a is located on the outer side of the first end surface 12e and exposed from the multilayer body 12. As such, each first internal electrode layer 16a is not exposed at the first main surface 12a, the second main surface 12b, the first lateral surface 12c, the second lateral surface 12d, or the second end surface 12f. In other words, an end of each first internal electrode layer 16a opposite to the exposed end is slightly spaced inward from the second end surface 12f.

The shape of the first counter electrode portion 26a of each first internal electrode layer 16a is not particularly limited, but is preferably rectangular or substantially rectangular in a plan view. However, corner portions thereof may be rounded in a plan view or sloped (tapered) in a plan view. Furthermore, the corner portions may each be tapered in a plan view with a slope toward one direction.

The shape of the first extension electrode portion 28a of each first internal electrode layer 16a is not particularly limited, but is preferably rectangular or substantially rectangular in a plan view. However, corner portions thereof may be rounded in a plan view or sloped (tapered) in a plan view. Furthermore, the corner portions may each be tapered in a plan view with a slope toward one direction.

The first counter electrode portion 26a of each first internal electrode layer 16a and the first extension electrode portion 28a of each first internal electrode layer 16a may have the same or substantially the same width, or either one may have a narrower width.

The second internal electrode layers 16b are disposed on the dielectric layers 14 and located inside the multilayer body 12. Each of the second internal electrode layers 16b includes a second counter electrode portion 26b opposed to adjacent first internal electrode layers 16a, and a second extension electrode portion 28b that is located at one end of the second internal electrode layer 16b and extends from the second counter electrode portion 26b to the second end surface 12f of the multilayer body 12. An end of the second extension electrode portion 28b is located on the outer side of the second end surface 12f and exposed from the multilayer body 12. As such, each second internal electrode layer 16b is not exposed at the first main surface 12a, the second main surface 12b, the first lateral surface 12c, the second lateral surface 12d, or the first end surface 12e. In other words, an end of each second internal electrode layer 16b opposite to the exposed end is slightly spaced inward from the first end surface 12e.

The shape of the second counter electrode portion 26b of each second internal electrode layer 16b is not particularly limited, but is preferably rectangular or substantially rectangular in a plan view. However, corner portions thereof may be rounded in a plan view or sloped (tapered) in a plan view. Furthermore, the corner portions may each be tapered in a plan view with a slope toward one direction.

The shape of the second extension electrode portion 28b of each second internal electrode layer 16b is not particularly limited, but is preferably rectangular or substantially rectangular in a plan view. However, corner portions thereof may be rounded in a plan view or sloped (tapered) in a plan view. Furthermore, the corner portions may each be tapered in a plan view with a slope toward one direction.

The second counter electrode portion 26b of each second internal electrode layer 16b and the second extension electrode portion 28b of each second internal electrode layer 16b may have the same or substantially the same width, or either one may have a narrower width.

The first internal electrode layers 16a and the second internal electrode layers 16b of the internal electrode layers 16 may be, for example, made of an electrically conductive material selected as appropriate from metals such as Ni, Cu, Ag, Pd, or Au, or alloys including at least one of these metals such as a Ag—Pd alloy. In a configuration in which base electrode layers of the external electrodes 30 described below include electrically conductive resin layers, the metal of the internal electrode layers 16 and a metal of an electrically conductive filler included in the electrically conductive resin layers define a compound.

No particular limitations are placed on the thickness of the first internal electrode layers 16a and the second internal electrode layers 16b. Preferably, each of the internal electrode layers 16a and the second internal electrode layers 16b has, for example, a thickness of about 0.2 μm or more and about 2.0 μm or less.

As shown in FIGS. 1 to 4, the external electrodes 30 are disposed on the first end surface 12e and the second end surface 12f of the multilayer body 12.

The external electrodes 30 include a first external electrode 30a and a second external electrode 30b.

The first external electrode 30a is electrically connected to the first internal electrode layers 16a and is provided on the outer side of the first end surface 12e. The first external electrode 30a extends along the multilayer body 12 from the first end surface 12e of the multilayer body 12 to also be provided on a portion of the first main surface 12a and a portion of the second main surface 12b, and a portion of the first lateral surface 12c and a portion of the second lateral surface 12d.

The second external electrode 30b is electrically connected to the second internal electrode layers 16b and is provided on the outer side of the second end surface 12f. The second external electrode 30b extends along the multilayer body 12 from the second end surface 12f of the multilayer body 12 to also be provided on a portion of the first main surface 12a and a portion of the second main surface 12b, and a portion of the first lateral surface 12c and a portion of the second lateral surface 12d.

In the multilayer body 12, the first counter electrode portions 26a of the first internal electrode layers 16a and the second counter electrode portions 26b of the second internal electrode layers 16b are opposed to each other with the dielectric layers 14 therebetween to generate capacitance. Capacitance can therefore be obtained between the first external electrode 30a connected to the first internal electrode layers 16a and the second external electrode 30b connected to the second internal electrode layers 16b, resulting in capacitor characteristics.

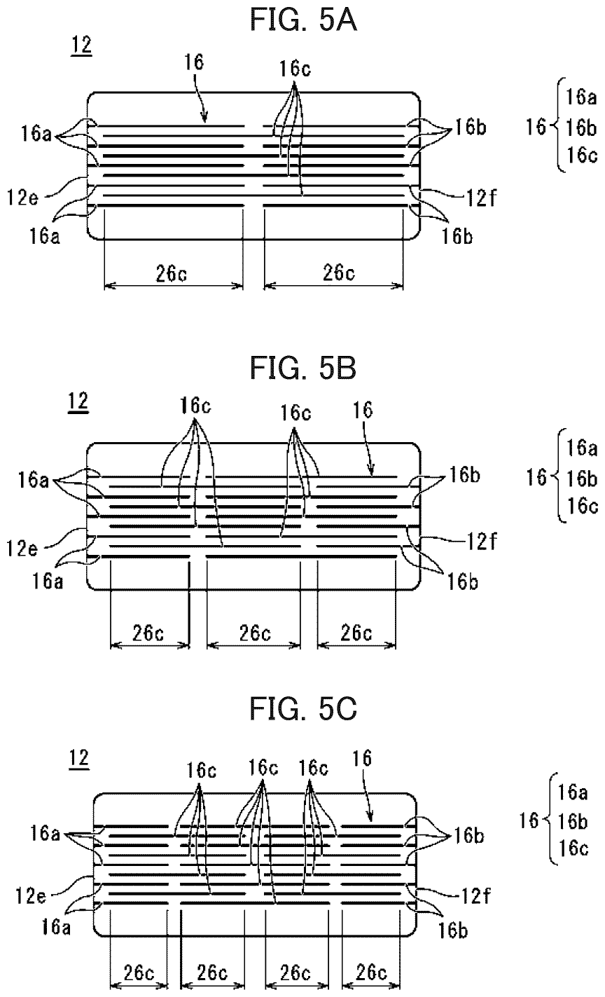

The multilayer body 12 shown in FIG. 1 may have a structure such as shown in FIGS. 5A to 5C, which includes floating internal electrode layers 16c that do not extend to the first end surface 12e or the second end surface 12f in addition to the first internal electrode layers 16a and the second internal electrode layers 16b, and which includes a plurality of separate counter electrode portions 26c based on the floating internal electrode layers 16c. For example, the multilayer body 12 may have a two-portion structure shown in FIG. 5A, a three-portion structure shown in FIG. 5B, or a four-portion structure shown in FIG. 5C. The multilayer body 12 may have a more than four-portion structure. As a result of the multilayer body 12 having a structure including the plurality of separate counter electrode portions 26c, a plurality of capacitor components are provided between the internal electrode layers 16a, 16b, and 16c opposed to each other, providing a configuration in which these capacitor components are connected in series. This configuration allows the voltage that is applied to each capacitor component to be reduced, to achieve higher voltage resistance of the multilayer ceramic capacitor 10.

Preferably, for example, each external electrode 30 has an internal configuration including a base electrode layer 32 including a metal component and a glass component, and a plated layer 34 disposed on a surface of the base electrode layer 32.

The base electrode layers 32 include a first base electrode layer 32a in the first external electrode 30a and a second base electrode layer 32b in the second external electrode 30b.

The first base electrode layer 32a is provided on the outer side of the first end surface 12e of the multilayer body 12, and extends from the first end surface 12e so as to cover a portion of the first main surface 12a and a portion of the second main surface 12b, and a portion of the first lateral surface 12c and a portion of the second lateral surface 12d.

The second base electrode layer 32b is provided on the outer side of the second end surface 12f of the multilayer body 12, and extends from the second end surface 12f so as to cover a portion of the first main surface 12a and a portion of the second main surface 12b, and a portion of the first lateral surface 12c and a portion of the second lateral surface 12d.

The first base electrode layer 32a may be provided only on the outer side of the first end surface 12e of the multilayer body 12, and the second base electrode layer 32b may be provided only on the outer side of the second end surface 12f of the multilayer body 12.

Preferably, each base electrode layer 32 includes, for example, at least one of a baked layer, an electrically conductive resin layer, or a thin film layer. The following describes baked layers that are provided as the base electrode layers.

The baked layers are obtained by applying an electrically conductive paste including a glass component and a metal onto the multilayer body 12 and baking the electrically conductive paste. The glass component of the baked layers includes, for example, at least one of B, Si, Ba, Zn, Mg, Al, or Li. The metal of the baked layers includes, for example, at least one of Cu, Ni, Ag, Pd, a Ag—Pd alloy, or Au.

The baked layers may be formed by simultaneously firing a multilayer chip having the internal electrode layers 16 and the dielectric layers 14, from which the multilayer body 12 is formed, and the electrically conductive paste applied onto the multilayer chip. Alternatively, the baked layers may be formed by baking the electrically conductive paste applied onto the multilayer body 12 after the multilayer body 12 has been formed by firing the multilayer chip. In a case where the multilayer chip and the electrically conductive paste applied onto the multilayer chip are simultaneously fired, the baked layers preferably include a dielectric material instead of the glass component. Each baked layer may include a single layer or a plurality of layers.

In a configuration in which a baked layer is provided as the first base electrode layer 32a, preferably, a central portion of the first base electrode layer 32a located on the first end surface 12e in the height direction x has, for example, a thickness of about 10 μm or more and about 150 μm or less in the length direction z. In a configuration in which a baked layer is provided as the second base electrode layer 32b, preferably, a central portion of the second base electrode layer 32b located on the second end surface 12f in the height direction x has, for example, a thickness of about 10 μm or more and about 150 μm or less in the length direction z.

In a configuration in which the baked layers are provided as the base electrode layers 32 on the first main surface 12a and the second main surface 12b, preferably, central portions of the first base electrode layer 32a located on the first main surface 12a and the second main surface 12b in the length direction z have, for example, a thickness of about 10 μm or more and about 100 μm or less in the direction connecting the first main surface 12a and the second main surface 12b, and central portions of the second base electrode layer 32b located on the first main surface 12a and the second main surface 12b in the length direction z have, for example, a thickness of about 10 μm or more and about 100 μm or less in the direction connecting the first main surface 12a and the second main surface 12b.

In a configuration in which the baked layers are provided as the base electrode layers 32 on the first lateral surface 12c and the second lateral surface 12d, preferably, central portions of the first base electrode layer 32a located on the first lateral surface 12c and the second lateral surface 12d in the length direction z have, for example, a thickness of about 10 μm or more and about 100 μm or less in the direction connecting the first lateral surface 12c and the second lateral surface 12d, and central portions of the second base electrode layer 32b located on the first lateral surface 12c and the second lateral surface 12d in the length direction z have, for example, a thickness of about 10 μm or more and about 100 μm or less in the direction connecting the first lateral surface 12c and the second lateral surface 12d.

The following describes electrically conductive resin layers that are provided as the base electrode layers. In a configuration in which electrically conductive resin layers are provided as the base electrode layers, the electrically conductive resin layers may be disposed directly on the multilayer body 12 or may be disposed so as to cover the baked layers or other material layers already provided as a portion of the base electrode layers.

In the latter case, the electrically conductive resin layers may cover the baked layers or other material layers completely or partially. Specifically, each of the electrically conductive resin layers provided as the first base electrode layer 32a and the second base electrode layer 32b is preferably provided to cover the corresponding one of the first end surface 12e and the second end surface 12f, and extend to cover a portion of the first main surface 12a and a portion of the second main surface 12b, and a portion of the first lateral surface 12c and a portion of the second lateral surface 12d. Alternatively, each of the electrically conductive resin layers provided as the first base electrode layer 32a and the second base electrode layer 32b may be provided to only cover the corresponding one of the first end surface 12e and the second end surface 12f.

Furthermore, the electrically conductive resin layers preferably have, for example, a thickness of about 10 μm or more and about 200 μm or less.

The electrically conductive resin layers are, for example, formed from a material including a thermosetting resin and a metal component such as electrically conductive particles. As a result of including a thermosetting resin, the electrically conductive resin layers are more flexible than, for example, electrically conductive layers made of a plated film or a fired electrically conductive paste. The electrically conductive resin layers can therefore define and function as buffer layers to prevent formation of cracks in the multilayer ceramic capacitor 10 even if the multilayer ceramic capacitor 10 is subjected to a physical shock or a shock resulting from thermal cycling.

Preferably, for example, the electrically conductive resin layers each include a metal in an amount of about 35 vol % or more and about 75 vol % or less relative to the total volume of the electrically conductive resin.

The metal included as electrically conductive particles in the electrically conductive resin layers is mainly responsible for the electrical conductivity of the electrically conductive resin layers. Specifically, particles of the electrically conductive filler make contact with each other to provide electrical paths inside the electrically conductive resin layers.

Examples of metals that can be included as electrically conductive particles in the electrically conductive resin layers include Ag, Cu, or an alloy including one or both of these metals.

Furthermore, metal particles each including a Ag-coated surface are also usable as the electrically conductive particles. In this case, preferably, for example, Cu or Ni is used as the metal. An Ag-coated metal is used for the electrically conductive particles because Ag has the lowest specific resistance among metals, and thus is suitable for electrode materials. Furthermore, Ag, which is a noble metal, does not oxidize and has higher weatherability. Furthermore, the use of a Ag-coated metal provides a choice for an inexpensive base material metal while maintaining the properties of Ag.

Antioxidant treated Cu, for example, is also usable as the metal included in the electrically conductive resin layers.

No particular limitations are placed on the particle shape of the metal contained in the electrically conductive resin layers. For example, a metal having a spherical or flat particle shape is usable. In the present example embodiment, in particular, spherical metal powder and flat metal powder are preferably used in combination. The electrically conductive filler may have, for example, a spherical or flat particle shape. No particular limitations are placed on the average particle diameter of the metal included in the electrically conductive resin layers. For example, the electrically conductive filler may have an average particle diameter of about 0.3 μm or more and about 10 μm or less.

Examples of resins suitable for the electrically conductive resin layers include various known thermosetting resins such as epoxy resins, phenol resins, urethane resins, silicone resins, and polyimide resins. In particular, epoxy resins, which have excellent heat resistance, moisture resistance, and adhesion, are one of the suitable resins.

Preferably, the electrically conductive resin layers include a curing agent along with the thermosetting resin. The electrically conductive resin layers may include, for example, an epoxy resin as the thermosetting resin, which is a base resin. Examples of curing agents usable for the epoxy resin include, for example, various known compounds such as phenol compounds, amine compounds, anhydride compounds, imidazole compounds, active ester compounds, and amide-imide compounds.

Each electrically conductive resin layer may include a single layer or a plurality of layers.

The following describes thin film layers that are provided as the base electrode layers. In a configuration in which thin film layers are provided as the base electrode layers, the thin film layers include deposited metal particles and have an average thickness of, for example, about 1 μm or less. The thin film layers are formed by a thin film formation method such as sputtering or vapor deposition, for example.

The plated layers 34 include a first plated layer 34a and a second plated layer 34b.

The first plated layer 34a and the second plated layer 34b include, for example, at least one of Cu, Ni, Sn, Ag, Pd, a Ag—Pd alloy, or Au.

The first plated layer 34a is disposed so as to cover the first base electrode layer 32a. The second plated layer 34b is disposed so as to cover the second base electrode layer 32b.

The first plated layer 34a and the second plated layer 34b may each include a plurality of layers. In this case, for example, the plated layer 34 preferably has a two-layer structure including a lower plated layer 36 provided on the base electrode layer 32 by Ni plating and an upper plated layer 38 provided on the lower plated layer 36 by Sn plating.

In other words, the first plated layer 34a includes a first lower plated layer 36a and a first upper plated layer 38a located on a surface of the first lower plated layer 36a. Similarly, the second plated layer 34b includes a second lower plated layer 36b and a second upper plated layer 38b located on a surface of the second lower plated layer 36b.

The lower plated layers 36 formed by Ni plating are used to prevent the base electrode layers 32 from being corroded by solder when the multilayer ceramic capacitor 10 is mounted, and the upper plated layers 38 formed by Sn plating are used to improve the wettability of solder when the multilayer ceramic capacitor 10 is mounted, facilitating the mounting.

Preferably, for example, the thickness per layer of the upper plated layers 38 is about 2.0 μm or more and about 15.0 μm or less.

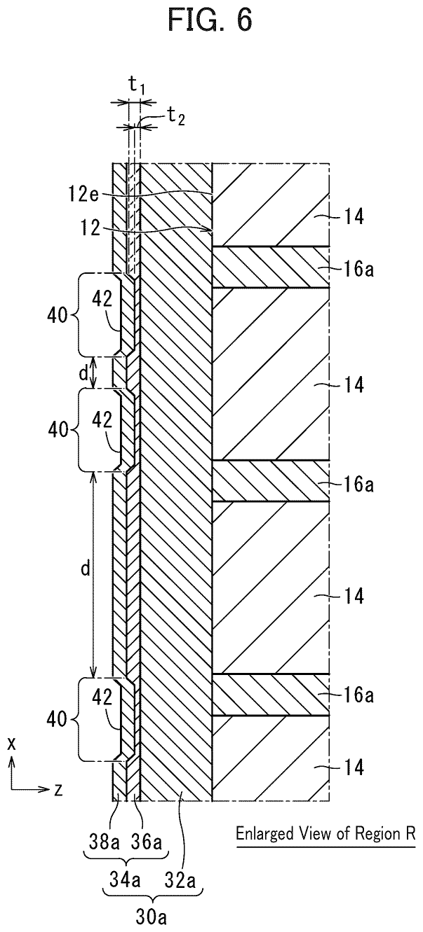

Furthermore, the first lower plated layer 36a of the first plated layer 34a includes thin layer regions 40 having a thickness smaller than the average thickness of the first lower plated layer 36a. Similarly, the second lower plated layer 36b of the second plated layer 34b includes thin layer regions 40 having a thickness smaller than the average thickness of the second lower plated layer 36b. The following describes the plated layers 34 in detail with reference to FIG. 6. FIG. 6 is a schematic diagram showing an enlarged view of a region R of the multilayer ceramic capacitor 10 in FIG. 2 including the first external electrode 30a located on the first end surface 12e and the vicinity thereof.

As shown in FIG. 6, the first lower plated layer 36a in the first plated layer 34a located adjacent to the first end surface 12e includes the thin layer regions 40 defined by recesses relative to the surface of the first lower plated layer 36a. Similarly, although not shown, the second lower plated layer 36b in the second plated layer 34b located adjacent to the second end surface 12f includes the thin layer regions 40 defined by recesses relative to the surface of the second lower plated layer 36b.

The first lower plated layer 36a and the second lower plated layer 36b including the thin layer regions 40 have an average thickness of, for example, about 2.0 μm or more and about 5.0 μm less. The average thickness of the first lower plated layer 36a and the second lower plated layer 36b is measured, for example, by a method of thickness test for metallic coating based on “JIS H8501:1999”.

If the average thickness of the first lower plated layer 36a and the second lower plated layer 36b including the thin layer regions 40 is less than about 2.0 μm, the plated layers 34 are too thin, resulting in a decrease in solderability. If the average thickness of the first lower plated layer 36a and the second lower plated layer 36b including the thin layer regions 40 is more than about 5.0 μm, the mechanical strength of the external electrodes 30 is too high, resulting in a decrease in resistance to damage resulting from bending of a mounting substrate.

The average thickness of the first lower plated layer 36a and the second lower plated layer 36b is measured, for example, as described below. Areas of the multilayer ceramic capacitor 10 including the lower plated layers 36, which are Ni plated layers, and excluding the thin layer regions 40 are irradiated with a fluorescent X-ray using an X-ray fluorescence thickness measuring device. Then, the amount of the fluorescent X-ray emitted from these lower plated layers is measured, and the thickness of the lower plated layers 36 is calculated based on the measurement value (refer to JIS H8501:1999 for more detail).

The first upper plated layer 38a, which is provided on the first lower plated layer 36a in the first plated layer 34a, has a uniform or substantially uniform average thickness. The first upper plated layer 38a therefore defines and functions as an upper layer of the first lower plated layer 36a, reflecting the surface shape of the first lower plated layer 36a, and surfaces of the thin layer regions 40 define recessed regions 42 of the first upper plated layer 38a. Similarly, the second upper plated layer 38b, which is provided on the second lower plated layer 36b in the second plated layer 34b, has a uniform or substantially uniform average thickness. The second upper plated layer 38b therefore defines and functions as an upper layer of the second lower plated layer 36b, reflecting the surface shape of the second lower plated layer 36b, and surfaces of the thin layer regions 40 define recessed regions 42 of the second upper plated layer 38b.

In the multilayer ceramic capacitor 10 having a configuration such as described above, the first lower plated layer 36a and the second lower plated layer 36b, which are, for example, Ni plated layers, of the first plated layer 34a and the second plated layer 34b in the external electrodes 30 include the thin layer regions 40 having a thickness smaller than the average thickness of the first lower plated layer 36a and the second lower plated layer 36b.

The thickness of the first lower plated layer 36a and the second lower plated layer 36b is partially reduced by providing the thin layer regions 40, thus enabling a reduction in overall strength of the first plated layer 34a and the second plated layer 34b while maintaining a good average thickness and a good surface condition in the first upper plated layer 38a and the second upper plated layer 38b.

This configuration enables satisfactory soldering while also achieving increased resistance to damage resulting from bending of a mounting substrate when the multilayer ceramic capacitor 10 is mounted on a mounting substrate by reducing the mechanical strength of the external electrodes 30 and reducing the likelihood of defective soldering.

Furthermore, in the multilayer ceramic capacitor 10, the ratio of the area of the thin layer regions 40 located on top of the first end surface 12e to the total area of the first lower plated layer 36a is, for example, preferably about 10% or higher and about 50% or lower. Similarly, the ratio of the area of the thin layer regions 40 located on top of the second end surface 12f to the total area of the second lower plated layer 36b is, for example, preferably about 10% or higher and about 50% or lower. In the case of the multilayer ceramic capacitor 10 in which the first lower plated layer 36a is also provided on top of the first main surface 12a and the second main surface 12b, the ratio of the area of the thin layer regions 40 located on top of the first main surface 12a to the total area of the first lower plated layer 36a is, for example, preferably about 10% or higher and about 50% or lower. Similarly, in the case of the multilayer ceramic capacitor 10 in which the second lower plated layer 36b is provided also on top of the first main surface 12a and the second main surface 12b, the ratio of the area of the thin layer regions 40 located on top of the second main surface 12b to the total area of the second lower plated layer 36b is, for example, preferably about 10% or higher and about 50% or lower. Furthermore, in the case of the multilayer ceramic capacitor 10 in which the first lower plated layer 36a is also provided on top of the first lateral surface 12c and the second lateral surface 12d, the ratio of the area of the thin layer regions 40 located on top of the first lateral surface 12c to the total area of the first lower plated layer 36a is, for example, preferably about 10% or higher and about 50% or lower. Similarly, in the case of the multilayer ceramic capacitor 10 in which the second lower plated layer 36b is also provided on top of the first lateral surface 12c and the second lateral surface 12d, the ratio of the area of the thin layer regions 40 located on top of the second lateral surface 12d to the total area of the second lower plated layer 36b is, for example, preferably about 10% or higher and about 50% or lower. This configuration helps more reliably produce the advantageous effects of enabling satisfactory soldering while also achieving increased resistance to damage resulting from bending of a mounting substrate when the multilayer ceramic capacitor 10 is mounted on the mounting substrate.

Specifically, if the ratio of the area of the thin layer regions 40 located on top of the first end surface 12e to the total area of the first lower plated layer 36a and the ratio of the area of the thin layer regions 40 located on top of the second end surface 12f to the total area of the second lower plated layer 36b are less than about 10%, it is difficult to maintain the strength of the first lower plated layer 36a and the second lower plated layer 36b low, preventing the above-described advantageous effects from being produced. On the other hand, if the ratio of the area of the thin layer regions 40 located on top of the first end surface 12e to the total area of the first lower plated layer 36a and the ratio of the area of the thin layer regions 40 located on top of the second end surface 12f to the total area of the second lower plated layer 36b are more than about 50%, it is difficult to form the first plated layer 34a and the second plated layer 34b.

The area of the first lower plated layer 36a, the area of the second lower plated layer 36b, and the area of the thin layer regions 40 are, for example, measured as described below. The first upper plated layer 38a and/or the second upper plated layer 38b in the external electrodes 30 are removed as desired through dissolution by applying a fluorinated plating release agent onto the multilayer ceramic capacitor 10 to expose the first lower plated layer 36a and/or the second lower plated layer 36b. The thus exposed surfaces and the vicinity thereof are observed using an electron microscope. Based on dimensions measured through the observation, the area of the surface of the first lower plated layer 36a and the area of each of the thin layer regions 40 located in this surface, and/or the area of the surface of the second lower plated layer 36b and the area of each of the thin layer regions 40 located in this surface are calculated.

Furthermore, in the multilayer ceramic capacitor 10, a thickness t2 of each of the thin layer regions 40 across the first lower plated layer 36a and the second lower plated layer 36b is, for example, preferably about ⅙ or more and about ⅔ or less of an average thickness t1 of the first lower plated layer 36a and the second lower plated layer 36b. In other words, the following condition is preferably satisfied: 1/6t1≤t2≤2/3t1. This configuration helps more reliably produce the advantageous effects of enabling satisfactory soldering while also achieving increased resistance to damage resulting from bending of a mounting substrate when the multilayer ceramic capacitor 10 is mounted on the mounting substrate.

If the thickness of the thin layer regions 40 is less than about ⅙ of the average thickness of the lower plated layers 36, it is impossible to form plating in regions corresponding to the thin layer regions 40, and it is also impossible to form Sn plated layers in these regions as the upper plated layers 38, thus increasing the likelihood of defective soldering in the external electrodes 30 and preventing the above-described advantageous effects from being produced. On the other hand, if the thickness of the thin layer regions 40 is more than about ⅔ of the average thickness of the lower plated layers 36, it is difficult to maintain the overall strength of the plated layers 34 low and reduce mechanical strength of the external electrodes 30, thus preventing the above-described advantageous effects from being produced.

Furthermore, in the multilayer ceramic capacitor 10, the thin layer regions 40 in the surface of the first lower plated layer 36a located on top of the first end surface 12e and the surface of the second lower plated layer 36b located on top of the second end surface 12f are, for example, preferably provided at intervals d of about 10 μm or more and about 300 μm or less in the lamination direction of the multilayer body 12 while satisfying the above-described thickness ratio relationship. This configuration helps more reliably produce the advantageous effects of enabling satisfactory soldering while also achieving increased resistance to damage resulting from bending of a mounting substrate when the multilayer ceramic capacitor 10 is mounted on the mounting substrate.

It is difficult to form the thin layer regions 40 at intervals d of less than about 10 μm from a manufacturing process perspective. If the thin layer regions 40 are formed at intervals d of more than about 300 μm, it is difficult to maintain the overall strength of the plated layers 34 low, thus preventing the above-described advantageous effects from being produced.

Furthermore, in the multilayer ceramic capacitor 10, the thin layer regions 40 preferably have a surface roughness Sz of, for example, about 1 μm or more and about 7 μm or less while satisfying the above-described thickness ratio relationship. The surface roughness Sz of the thin layer regions 40 is defined using the difference between the maximum value and the minimum value of the thickness t2 of the thin layer regions 40. This configuration helps more reliably produce the advantageous effects of enabling satisfactory soldering while also achieving increased resistance to damage resulting from bending of a mounting substrate when the multilayer ceramic capacitor 10 is mounted on the mounting substrate.

If the surface roughness Sz of the surfaces of the thin layer regions 40 is less than about 1 μm, it is difficult to maintain the overall strength of the plated layers 34 low, thus preventing the above-described advantageous effects from being produced. On the other hand, if the surface roughness Sz of the surfaces of the thin layer regions 40 is more than about 7 μm, the formation of the plated layers 34 itself is difficult.

The surface roughness Sz of the thin layer regions 40 is, for example, measured as described below by a measurement method according to ISO 25178. The first upper plated layer 38a and/or the second upper plated layer 38b in the external electrodes 30 are removed as desired through dissolution by applying a fluorinated plating release agent onto the multilayer ceramic capacitor 10 to expose the first lower plated layer 36a and/or the second lower plated layer 36b. The thus exposed surfaces are observed using a non-contact laser microscope, and the surface roughness Sz is determined as an actually measured value. The measurement may be performed on the multilayer body 12 on which the first lower plated layer 36a and/or the second lower plated layer 36b for the multilayer ceramic capacitor 10 have been formed.

A dimension of the multilayer ceramic capacitor 10 including the multilayer body 12, the first external electrode 30a, and the second external electrode 30b in the length direction z is referred to as an L dimension. A dimension of the multilayer ceramic capacitor 10 including the multilayer body 12, the first external electrode 30a, and the second external electrode 30b in the height direction x is referred to as a T dimension. A dimension of the multilayer ceramic capacitor 10 including the multilayer body 12, the first external electrode 30a, and the second external electrode 30b in the width direction y is referred to as a W dimension. The multilayer ceramic capacitor 10 has, for example, an L dimension in the length direction z of about 0.2 mm or more and about 10.0 mm or less, a W dimension in the width direction y of about 0.1 mm or more and about 10.0 mm or less, and a T dimension in the height direction x of about 0.1 mm or more and about 5.0 mm or less. The dimensions of the multilayer ceramic capacitor 10 can be measured using a microscope, for example.

In the multilayer ceramic capacitor 10 shown in FIG. 1, the first lower plated layer 36a and the second lower plated layer 36b, which are, for example, Ni plated layers, of the first plated layer 34a and the second plated layer 34b in the external electrodes 30 include the thin layer regions 40 having a thickness smaller than the average thickness of the first lower plated layer 36a and the second lower plated layer 36b, and the average thickness of the first lower plated layer 36a and the second lower plated layer 36b is, for example, about 2.0 μm or more and about 5.0 μm or less. This configuration enables satisfactory soldering while also achieving increased resistance to damage resulting from bending of a mounting substrate when the multilayer ceramic capacitor 10 is mounted on the mounting substrate.

Furthermore, in the multilayer ceramic capacitor 10 shown in FIG. 1, the ratio of the area of the thin layer regions 40 located on top of the first end surface 12e to the total area of the first lower plated layer 36a and the ratio of the area of the thin layer regions 40 located on top of the second end surface 12f to the total area of the second lower plated layer 36b are, for example, preferably about 10% or higher and about 50% or lower. This configuration helps more reliably produce the advantageous effects of enabling satisfactory soldering while also achieving increased resistance to damage resulting from bending of a mounting substrate when the multilayer ceramic capacitor 10 is mounted on the mounting substrate.

### 2. Multilayer Ceramic Capacitor Manufacturing Method

The following describes an example of a method for manufacturing the multilayer ceramic capacitor according to the present invention.

### Preparation

First, dielectric sheets for forming dielectric layers and an electrically conductive paste for forming internal electrode layers that define and functions as the first internal electrode layers and the second internal electrode layers are prepared. The dielectric sheets to be prepared include those on which the first internal electrode layers are provided, those on which the second internal electrode layers are provided, and those on which no internal electrode layer is provided. The dielectric sheets and the electrically conductive paste each include a binder and a solvent. The dielectric sheets and the electrically conductive paste may include a known binder and a known solvent.

### Multilayer Sheet Production

Next, the electrically conductive paste for forming internal electrode layers is printed on dielectric sheets in predetermined patterns by, for example, screen printing or gravure printing. As a result, dielectric sheets including a first internal electrode layer pattern and dielectric sheets having a second internal electrode layer pattern are prepared.

Dielectric sheets including no internal electrode layer pattern printed thereon are also prepared for forming outer layers.

Subsequently, a predetermined number of dielectric sheets with no internal electrode layer pattern printed thereon for forming outer layers are laminated to form a laminate that serves as the second main surface-side outer layer portion. On top of the laminate that defines and functions as the second main surface-side outer layer portion, the dielectric sheets with the first internal electrode layer pattern printed thereon and the dielectric sheets with the second internal electrode layer pattern printed thereon are sequentially laminated so as to give the structure of the present invention. As a result, a laminate that defines and functions as the inner layer portion is formed. On top of the laminate that defines and functions as the inner layer portion, a predetermined number of dielectric sheets with no internal electrode layer pattern printed thereon for forming outer layers are laminated to form a laminate that serves as the first main surface-side outer layer portion.

### Multilayer Block Production

Next, the resulting multilayer sheet is pressed in the lamination direction of the dielectric sheets by, for example, a hydrostatic press or other method to produce a multilayer block.

### Multilayer Chip Production

A plurality of multilayer chips are cut out from the multilayer block by cutting the multilayer block into a predetermined size. In this step, corner portions and ridge portions of each multilayer chip may be rounded by barrel polishing or other method.

### Multilayer Body Production

Each multilayer chip is fired to produce a multilayer body. The firing temperature depends on the material of the dielectric sheets and the material of the internal electrode layers, but is, for example, preferably about 900° C. or higher and about 1400° C. or lower.

### External Electrode Formation

### (a) Configuration Including Baked Layers

The following describes formation of baked layers as the base electrode layers. Baked layers are formed as the base electrode layers by preparing, applying, and then baking an electrically conductive paste including a glass component and a metal.

The first base electrode layer of the first external electrode and the second base electrode layer of the second external electrode are formed on the first end surface and the second end surface of the multilayer body.

The baked layers are, for example, formed by an application method such as dipping or screen printing. The electrically conductive paste is applied onto the first end surface and the second end surface of the multilayer body, and then baked. The baking temperature is, for example, preferably about 700° C. or higher and about 900° C. or lower.

### (b) Configuration Including Electrically Conductive Resin Layers

In a configuration in which electrically conductive resin layers are formed as the first base electrode layer and the second base electrode layer, the following method can be used. The electrically conductive resin layers may be formed on surfaces of the baked layers, or may be formed directly on the multilayer body without forming the baked layers therebetween.

The electrically conductive resin layers are formed by applying an electrically conductive resin paste including a thermosetting resin and a metal component onto the baked layers or the multilayer body, and thermally curing the resin through heat treatment at a temperature of, for example, about 250° C. or higher and about 550° C. or lower. Preferably, for example, the heat treatment is performed under a N₂ atmosphere. Preferably, for example, the oxygen concentration is maintained at about 100 ppm or lower to prevent scattering of the resin and oxidation of any metal component.

The electrically conductive resin paste can be, for example, applied by using a method involving extruding the electrically conductive resin paste through a slit or a roller transfer method, which can be also employed for forming the baked layers as the base electrode layers.

### (c) Configuration Including Thin Film Layers

In a configuration in which thin film layers are formed as the first base electrode layer and the second base electrode layer, the thin film layers are formed by, for example, masking or otherwise covering areas other than desired areas where the external electrodes are to be formed, and performing sputtering, vapor deposition, or other thin film formation method on the desired areas thus exposed.

### Plated Layer Formation

Subsequently, the first plated layer and the second plated layer are formed. The first plated layer and the second plated layer are respectively formed on surfaces of the first base electrode layer and the second base electrode layer. More specifically, for example, a Ni plated layer is formed as a first lower plated layer on a surface of the first base electrode layer, and a Sn plated layer is formed as a first upper plated layer on a surface of the first lower plated layer. Similarly, for example, a Ni plated layer is formed as a second lower plated layer on a surface of the second base electrode layer, and a Sn plated layer is formed as a second upper plated layer on a surface of the second lower plated layer. Each plated layer is formed through plating according to a barrel plating method.

Among the steps described above, the step for forming Ni plated layers as the first lower plated layer and the second lower plated layer includes a step for forming thin layer regions in the first lower plated layer and the second lower plated layer by partially reducing the thickness of these layers. Various known and conventional technical methods can be used to perform this step. For example, the multilayer body and media are placed in a barrel to be used for the plating. In the step for forming thin layer regions, desired thin layer regions are formed by controlling some or all of the shape of a barrel container, the type of media, the diameter and the amount of media, the concentration of a plating solution in a plating tank where the barrel is placed, the amount of additives, and the value of electric current. Specifically, for example, the diameter of the media is preferably in a range of from about 0.1 mm to about 10 mm, and the amount of media is preferably in a range of from about 30% to about 70% of the total amount.

The ratio of the area of the thin layer regions located adjacent to the first end surface to the total area of the first lower plated layer and the ratio of the area of the thin layer regions located adjacent to the second end surface to the total area of the second lower plated layer can be controlled to be, for example, about 10% or higher and about 50% or lower by controlling the diameter and the amount of media, the amount of additives, and the value of electric current.

As described above, the multilayer ceramic capacitor according to the foregoing example embodiment of the present invention is obtained.

### 3. Experimental Example

Examples and Comparative Examples of the multilayer ceramic capacitor 10 according to example embodiments of the present invention were produced in accordance with the manufacturing method described above, and a solderability test and a substrate bending damage resistance evaluation test were conducted.

### (a) Specifications of Samples According to Examples and Comparative Examples

Multilayer ceramic capacitors with the following specifications were prepared as Examples 1 to 16 and Comparative Examples 1 to 8. The specifications of the multilayer ceramic capacitors prepared are shown below.
Dimensions of multilayer ceramic capacitor (design values): L×W×T=about 2.0 mm×about 1.6 mm×about 1.6 mm
Material of main component of dielectric layers: BaTiO₃
Capacitance: about 10 μF
Rated voltage: about 16 V
Electrode material of internal electrode layers: Ni
Structure of external electrodes
(i) First base electrode layer and second base electrode layer: baked layers (including electrically conductive metal (Cu) and glass component)
(ii) First plated layer and second plated layer: two-layer structure including Ni plated layer (lower layer) and Sn plated layer (upper layer)
Average thickness of Ni plated layer: see Table 1
Average thickness of Sn plated layer: about 4 μm

As shown in Table 1, the area ratio of the thin layer regions in the samples according to Examples and Comparative Examples was varied in the range of from about 10% to about 50% by controlling the diameter and the amount of media, the amount of additives, and the value of electric current in the step for forming thin layer regions.

### (b) Solderability Test

The samples according to Examples 1 to 16 and Comparative Examples 1 to 8 were each mounted on a JIS substrate (glass epoxy substrate) having a thickness of about 1.6 mm using a solder paste. The substrates each having a sample mounted thereon were put into a reflow furnace for soldering. The amount of positional deviation of each soldered sample was measured and the appearance of each soldered sample was observed to evaluate solderability based on the presence or absence of positional deviation and the integrity of the plating. In the solderability test, evaluations were made in accordance with two criteria: Good (indicated by circle symbol (o)) and Poor (indicated by cross symbol (x)). Detailed evaluation criteria are shown below. For each of Examples and Comparative Examples, 1000 samples were evaluated.
Good (indicated by circle symbol (o)): positional deviation or plating flaking occurred in 0 to 9 samples out of 1000 samples
Poor (indicated by cross symbol (x)): positional deviation or plating flaking occurred in 10 or more samples out of 1000 samples

### (c) Substrate Bending Damage Resistance Test

The samples according to Examples 1 to 16 and Comparative Examples 1 to 8 were each mounted on a JIS substrate (glass epoxy substrate) having a thickness of about 1.6 mm using a solder paste. The substrates each having a sample mounted thereon were put into a reflow furnace for soldering. After the mounting of each sample on the substrate, mechanical stress was applied to a surface of the substrate where no sample was mounted by pressing and thus bending the substrate using a metal pressing rod having a rounded tip of about 5±0.1 mm in diameter. The substrate was maintained bent for about five seconds with a deflection amount of about 1.5 mm. Thereafter, each sample multilayer ceramic capacitor was polished so that the length direction z of the sample was divided into two equal or substantially equal portions to expose a WT cross-section, and the thus exposed WT cross-section was observed. Thus, the occurrence of cracking in each sample was evaluated. For each of Examples and Comparative Examples, 200 samples were evaluated. In the substrate bending damage resistance test, evaluations were made in accordance with two criteria: Good (indicated by circle symbol (o)) and Poor (indicated by cross symbol (x)). Detailed evaluation criteria are shown below.
Good (indicated by circle symbol (o)): cracking occurred in 0 to 9 samples out of 200 samples
Poor (indicated by cross symbol (x)): cracking occurred in 10 or more samples out of 200 samples

### (d) Results

Table 1 shows the evaluation results of the solderability test and the substrate bending damage resistance test for the samples according to Examples 1 to 16 and Comparative Examples 1 to 8.

TABLE 1

| | | Area Ratio of | | | | | |
|---|---|---|---|---|---|---|---|
| | Average | Thin Layer | | | Substrate Bending Damage | | |
| | Thickness | Regions | Solderability Test | | Resistance Test | | Overall |
| | (mm) | (%) | (samples) | Evaluation | (samples) | Evaluation | Evaluation |
| Example 1 | 2.0 | 50 | 9/1000 | ◯ | 0/200 | ◯ | ◯ |
| Example 2 | 2.0 | 40 | 0/1000 | ◯ | 0/200 | ◯ | ◯ |
| Example 3 | 2.0 | 20 | 0/1000 | ◯ | 0/200 | ◯ | ◯ |
| Example 4 | 2.0 | 10 | 0/1000 | ◯ | 0/200 | ◯ | ◯ |
| Example 5 | 3.0 | 50 | 0/1000 | ◯ | 0/200 | ◯ | ◯ |
| Example 6 | 3.0 | 40 | 0/1000 | ◯ | 0/200 | ◯ | ◯ |
| Example 7 | 3.0 | 20 | 0/1000 | ◯ | 0/200 | ◯ | ◯ |
| Example 8 | 3.0 | 10 | 0/1000 | ◯ | 0/200 | ◯ | ◯ |
| Example 9 | 4.0 | 50 | 0/1000 | ◯ | 2/200 | ◯ | ◯ |
| Example 10 | 4.0 | 40 | 0/1000 | ◯ | 0/200 | ◯ | ◯ |
| Example 11 | 4.0 | 20 | 0/1000 | ◯ | 0/200 | ◯ | ◯ |
| Example 12 | 4.0 | 10 | 0/1000 | ◯ | 0/200 | ◯ | ◯ |
| Example 13 | 5.0 | 50 | 0/1000 | ◯ | 4/200 | ◯ | ◯ |
| Example 14 | 5.0 | 40 | 0/1000 | ◯ | 5/200 | ◯ | ◯ |
| Example 15 | 5.0 | 20 | 0/1000 | ◯ | 3/200 | ◯ | ◯ |
| Example 16 | 5.0 | 10 | 0/1000 | ◯ | 0/200 | ◯ | ◯ |
| Comparative Example 1 | 1.0 | 50 | 65/1000 | X | 0/200 | ◯ | X |
| Comparative Example 2 | 1.0 | 40 | 35/1000 | X | 0/200 | ◯ | X |
| Comparative Example 3 | 1.0 | 20 | 21/1000 | X | 0/200 | ◯ | X |
| Comparative Example 4 | 1.0 | 10 | 14/1000 | X | 0/200 | ◯ | X |
| Comparative Example 5 | 6.0 | 50 | 0/1000 | ◯ | 16/200 | X | X |
| Comparative Example 6 | 6.0 | 40 | 0/1000 | ◯ | 13/200 | X | X |
| Comparative Example 7 | 6.0 | 20 | 0/1000 | ◯ | 15/200 | X | X |
| Comparative Example 8 | 6.0 | 10 | 0/1000 | ◯ | 11/200 | X | X |

The “Area ratio of thin layer regions” in Table 1 refers to the ratio of the area of the thin layer regions of the Ni plated layers to the total area of the Ni plated layers.

The results shown in Table 1 suggest that the samples according to Examples 1 to 16 enabled satisfactory soldering while also achieving increased resistance to damage resulting from bending of the mounting substrates when the samples were mounted on the mounting substrates since the lower plated layers thereof had, for example, an average thickness of about 2.0 μm or more and about 5.0 μm or less, and the lower plated layers thereof included the thin layer regions. The results of the substrate bending damage resistance test suggest that the samples according to Examples 13 to 15, in which the lower plated layers 36 had, for example, an average thickness of about 5.0 μm, were slightly more susceptible to cracking.

In contrast, the samples according to Comparative Examples 1 to 4 were evaluated to be good in the substrate bending damage resistance test, but included more than 10 samples with positional deviation or plating flaking that occurred as a result of the solderability test, because the lower plated layers 36 thereof had an average thickness of about 1.0 μm. Furthermore, the samples according to Comparative Examples 5 to 8 were evaluated to be good in the solderability test, but included more than 10 samples with cracking that occurred as a result of the substrate bending damage resistance test.

These results demonstrate that multilayer ceramic capacitor according to example embodiments of the present invention enable satisfactory soldering while also achieving increased resistance to damage resulting from bending of a mounting substrate when the multilayer ceramic capacitor is mounted on the mounting substrate, as long as lower plated layers thereof have an average thickness of, for example, about 2.0 μm or more and about 5.0 μm less, and the lower plated layers included thin layer regions.

Although example embodiments of the present invention have been described above, the present invention is not limited thereto.

The multilayer ceramic capacitor 10 according to the foregoing example embodiments is described as a two-terminal capacitor that includes the two external electrodes 30, i.e., the first external electrode 30a and the second external electrode 30b, but may alternatively be a three-terminal or four-terminal capacitor. That is to say, the multilayer ceramic capacitors according to example embodiments of the present invention may have any configuration as long as the configuration includes a multilayer body including a plurality of internal electrode layers opposed to each other and arranged with space therebetween, and insulating layers including a ceramic material disposed between the plurality of internal electrode layers, and a plurality of external electrodes provided on surfaces of the multilayer body and selectively connected to the plurality of internal electrode layers. Other specific aspects of the configuration are not limited, such as the number and the shape of the external electrodes and the internal electrode layers connected to the external electrodes.

Various modifications can be made to the above-described example embodiments with regard to configurations, shapes, materials, number and quantities, positions, arrangements, or the like without departing from the scope of the technical idea of the present invention, and these modifications are included in the present invention as well as the above-described example embodiments.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A multilayer ceramic capacitor comprising:
a multilayer body including a plurality of dielectric layers and a plurality of internal electrode layers laminated in a lamination direction, a first main surface and a second main surface opposed to each other in the lamination direction, a first lateral surface and a second lateral surface opposed to each other in a width direction orthogonal or substantially orthogonal to the lamination direction, and a first end surface and a second end surface opposed to each other in a length direction orthogonal or substantially orthogonal to the lamination direction and the width direction;
a first external electrode on the first end surface; and
a second external electrode on the second end surface; wherein
the first external electrode and the second external electrode each include:
a base electrode layer;
a lower plated layer on a surface of the base electrode layer; and
an upper plated layer on a surface of the lower plated layer;
the lower plated layer has an average thickness of about 2.0 μm or more and about 5.0 μm or less; and
the lower plated layer includes thin layer regions with a thickness smaller than the average thickness of the lower plated layer.

2. The multilayer ceramic capacitor according to claim 1,
wherein a ratio of an area of the thin layer regions of the lower plated layer located on top of each of the first end surface and the second end surface to a total area of the lower plated layer is about 10% or higher and about 50% or lower.

3. The multilayer ceramic capacitor according to claim 1, wherein
the lower plated layer includes Ni as a main component; and
the upper plated layer includes Sn as a main component.

4. The multilayer ceramic capacitor according to claim 1, wherein each of the plurality of dielectric layers includes BaTiO₃, CaTiO₃, SrTiO₃, or CaZrO₃ as a main component.

5. The multilayer ceramic capacitor according to claim 4, wherein each of the plurality of dielectric layers includes a Mn compound, an Fe compound, a Cr compound, a Co compound, or a Ni compound as a subcomponent.

6. The multilayer ceramic capacitor according to claim 1, wherein a thickness of each of the plurality of dielectric layers is about 0.5 μm or more and about 10 μm or less.

7. The multilayer ceramic capacitor according to claim 1, wherein the plurality of internal electrode layers include first internal electrode layers connected to the first external electrode, and second internal electrode layers connected to the second external electrode.

8. The multilayer ceramic capacitor according to claim 1, wherein each of the plurality of internal electrode layers includes Ni, Cu, Ag, Pd, or Au, or an alloy including at least one of Ni, Cu, Ag, Pd, or Au.

9. The multilayer ceramic capacitor according to claim 1, wherein a thickness of each of the plurality of internal electrode layers is about 0.2 μm or more and about 2.0 μm or less.

10. The multilayer ceramic capacitor according to claim 1, wherein the base electrode layer includes a baked layer including a metal component and a glass component.

11. The multilayer ceramic capacitor according to claim 10, wherein the glass component includes at least one of B, Si, Ba, Zn, Mg, Al, or Li.

12. The multilayer ceramic capacitor according to claim 10, wherein the metal component includes at least one of Cu, Ni, Ag, Pd, a Ag—Pd alloy, or Au.

13. The multilayer ceramic capacitor according to claim 10, wherein a thickness of the baked layer at a central portion in the height direction is about 10 μm or more and about 150 μm or less.

14. The multilayer ceramic capacitor according to claim 1, wherein each of the first and second external electrodes extends portion of each of the first and second main surfaces and the first and second lateral surfaces.

15. The multilayer ceramic capacitor according to claim 1, wherein the base electrode layer includes an electrically conductive resin layer.

16. The multilayer ceramic capacitor according to claim 15, wherein a thickness of the electrically conductive resin layer is about 10 μm or more and about 200 μm or less.

17. The multilayer ceramic capacitor according to claim 15, wherein the electrically conductive resin layer includes a thermosetting resin and a metal component.

18. The multilayer ceramic capacitor according to claim 17, wherein the metal component of the electrically conductive resin layer is included in an amount of about 35 vol % or more and about 75 vol % or less relative to a total volume of the electrically conductive resin layer.
